(19) United States
(12) Patent Application Publication
(10) Pub. No.: US 2018/0254998 A1
(43) Pub. Date: Sep. 6, 2018

(54) RESOURCE ALLOCATION IN A CLOUD ENVIRONMENT

(71) Applicant: ALCATEL LUCENT, Boulogne-Billancourt (FR)

(72) Inventors: Marco Cello, Dublin (IE); Jesus Alberto Omana Iglesias, Dublin (IE); Diego F. Lugones, Dublin (IE)

(73) Assignee: ALCATEL LUCENT, Boulogne-Billancourt (FR)

(21) Appl. No.: 15/447,665

(22) Filed: Mar. 2, 2017

(51) Int. Cl. H04L 12/911; H04L 29/08; H04L 12/26

(52) U.S. Cl. CPC H04L 47/82; H04L 43/045; H04L 67/10

(57) ABSTRACT

We disclose a cloud-computing system configurable to allocate cloud resources to application functions based on a performance model generated for some or all of such functions by monitoring the performance of an instance pool employed for their execution. In an example embodiment, a corresponding performance model is generated by iteratively forcing the instance pool, during a learning phase, to operate in a manner that enables a control entity of the cloud-computing system to adequately sample different sub-ranges of an operational range, thereby providing a sufficient set of performance data points to a model-building module thereof. The model-building module operates to generate the performance model using a sufficient set of performance data points and then provides the model parameters to the control entity, wherein the model parameters can be used, e.g., to optimally configure and allocate the cloud resources to the application functions during subsequent operation.

### BACKGROUND

### Field

The present disclosure relates to cloud computing and, more specifically but not exclusively, to managing resource allocation in a cloud environment.

### Description of the Related Art

This section introduces aspects that may help facilitate a better understanding of the disclosure. Accordingly, the statements of this section are to be read in this light and are not to be understood as admissions about what is in the prior art or what is not in the prior art.

Cloud computing is a model that enables customers to conveniently access, on demand, a shared pool of configurable computing resources, such as networks, platforms, servers, storage, applications, and services. These resources can typically be rapidly provisioned and then released with little or no interaction with the service provider, e.g., using automated processes. The customer can be billed based on the actual resource consumption and be freed from the need to own and/or maintain the corresponding resource infrastructure. As such, cloud computing has significantly expanded the class of individuals and companies that can be competitive in their respective market segments.

Serverless computing, also sometimes referred to as function as a service (FaaS), is a relatively new cloud-computing paradigm that defines applications as a set of stateless, and typically small and agile, functions with access to a data store. These functions are triggered by external and/or internal events or other functions, forming function chains than can fluctuate arbitrarily and/or grow and contract very fast. The customers do not typically need to specify and configure cloud instances, e.g., virtual machines (VMs) and/or containers, to run such functions on. As a result, substantially all of the configuration and dynamic management of the resources becomes the responsibility of the cloud operator. In addition, there are implications from a billing perspective that will require more-efficient and sophisticated techniques for orchestration of resources, e.g., to allocate and reassign the resources on the fly without hampering the quality of service (QoS). In this context, resource allocation and management may benefit from an evolved new class of smart techniques that can help to minimize waste of resources and allocate optimal amounts of them, e.g., to fulfill user requests at a minimal cost. Such techniques are currently under development in the cloud-computing community.

### SUMMARY OF SOME SPECIFIC EMBODIMENTS

Disclosed herein are various embodiments of a cloud-computing system configurable to allocate cloud resources to application functions based on a performance model generated for some or all of such functions by monitoring the performance of an instance pool employed for their execution. In an example embodiment, a corresponding performance model is generated by iteratively forcing the instance pool, during a learning phase, to operate in a manner that enables a control entity of the cloud-computing system to adequately sample different sub-ranges of an operational range, thereby providing a sufficient set of performance data points to a model-building module thereof. The model-building module operates to generate the performance model using a sufficient set of performance data points and then provides the model parameters to the control entity, wherein the model parameters can be used, e.g., to optimally configure and allocate the cloud resources to the application functions during subsequent operation.

In an example embodiment, the cloud-computing system can support a serverless application comprising a plurality of stateless functions, the state information for which is stored in the system's memory and fetched therefrom during an execution of a function, with the execution being delegated to the instance pool. Optimal allocation of the cloud resources that relies on the performance model can be directed at satisfying any number of constraints, such as energy consumption, cost, desired level of hardware utilization, performance tradeoffs, etc.

According to an example embodiment, provided is an apparatus comprising: an automated control entity operatively connected to an instance pool configurable to process requests that invoke a function of a computing application that is executable using a cloud environment, the instance pool being a part of the cloud environment; and a characterization module operatively connected to the automated control entity and configured to: generate a first set of data points by processing a log of events corresponding to a first instance allocated in the instance pool to processing the requests, the log of events being received by the characterization module from the automated control entity; and generate a first control signal configured to cause the control entity to change a number of instances allocated to the processing of the requests in the instance pool in response to a determination of insufficiency having been made by the characterization module with respect to the first set of data points.

According to another example embodiment, provided is a machine-implemented method of configuring a cloud environment, the method comprising the steps of: generating a first set of data points by processing a log of events corresponding to a first instance allocated in an instance pool to processing requests that invoke a function executed using the cloud environment; and generating a first control signal to change a number of instances allocated to the processing of said requests in the instance pool in response to a determination of insufficiency having been made with respect to the first set of data points.

According to yet another example embodiment, provided is a non-transitory machine-readable medium, having encoded thereon program code, wherein, when the program code is executed by a machine, the machine implements a computer-aided method of configuring a cloud environment, the computer-aided method comprising the steps of: generating a first set of data points by processing a log of events corresponding to a first instance allocated in an instance pool to processing requests that invoke a function executed using the cloud environment; and generating a first control signal to change a number of instances allocated to the processing of said requests in the instance pool in response to a determination of insufficiency having been made with respect to the first set of data points.

### BRIEF DESCRIPTION OF THE DRAWINGS

Other aspects, features, and benefits of various disclosed embodiments will become more fully apparent, by way of example, from the following detailed description and the accompanying drawings, in which:

FIG. 1 schematically shows the architecture of a cloud-computing system according to an example embodiment;

FIG. 2 graphically illustrates example data processing that can be implemented in the characterization module of the cloud-computing system of FIG. 1 according to an embodiment;

FIG. 3 graphically shows an example sufficient set of data points according to an embodiment;

FIGS. 4A-4B graphically show example insufficient sets of data points according to an embodiment;

FIG. 5 shows a flowchart of an operating method that can be implemented in the characterization module of the cloud-computing system of FIG. 1 according to an embodiment; and

FIG. 6 shows a block diagram of a networked computer that can be used in the cloud-computing system of FIG. 1 according to an embodiment.

### DETAILED DESCRIPTION

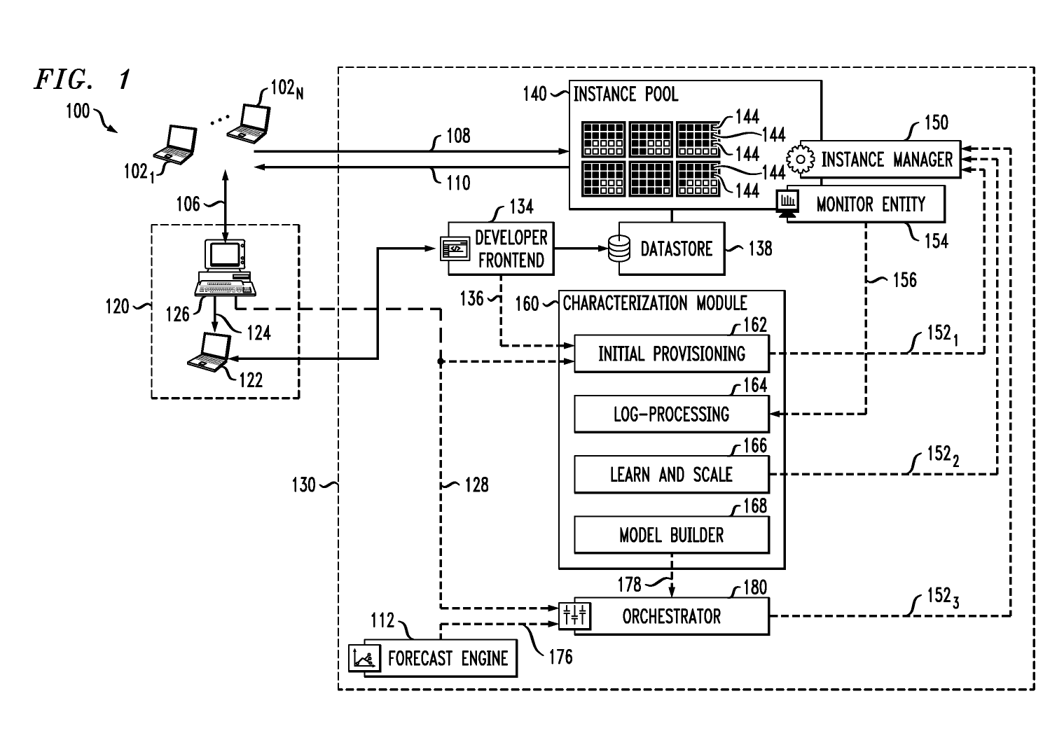

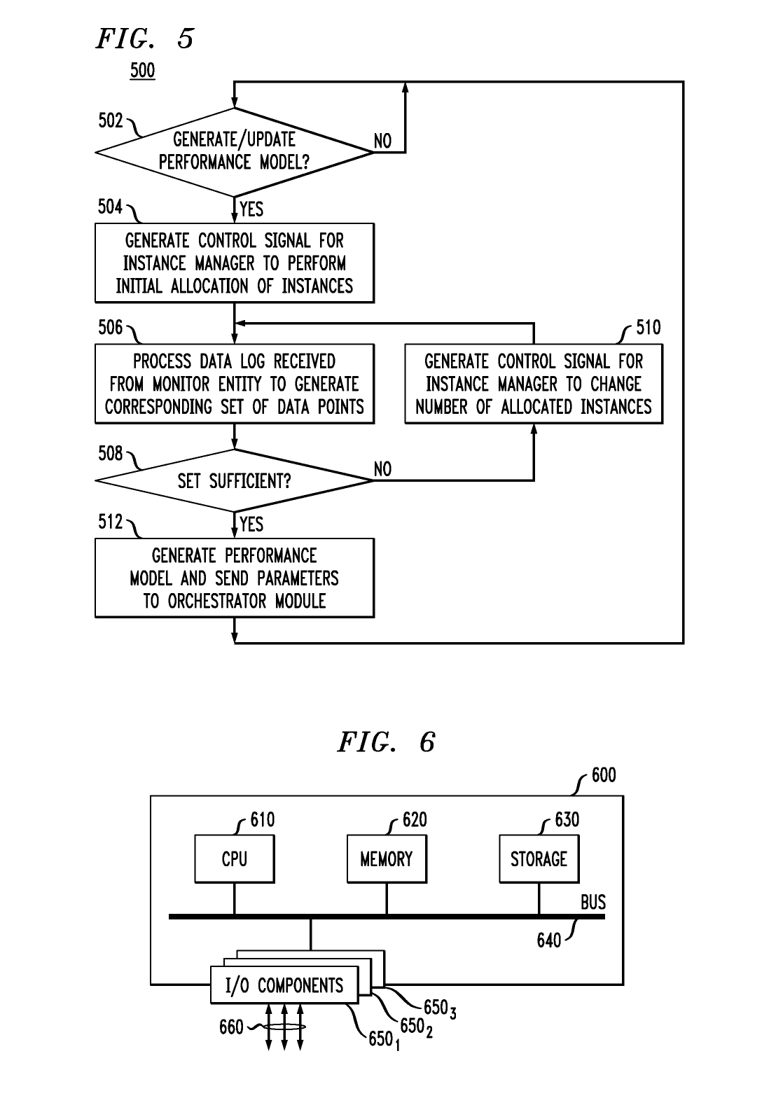

FIG. 1 schematically shows the architecture of a cloud-computing system 100 according to an example embodiment. System 100 comprises a cloud-computing service provider 130 that provides an infrastructure platform upon which a cloud environment can be supported. In an example embodiment, the infrastructure platform has hardware resources configured to support the execution of a plurality of virtual machines (also often referred to as instances or containers) and service modules that control and support the operation of the cloud environment. Example hardware that can be part of the hardware resources used by cloud-computing service provider 130 is described in more detail below in reference to FIG. 6.

In some embodiments, system 100 can be designed and configured for serverless computing and employ a corresponding serverless platform, serverless cloud infrastructure, etc. As used herein, the term “serverless” refers to a relatively high level of abstraction in cloud computing. The use of this term should not be construed to mean that there are no servers in the corresponding system, such as system 100, but rather be interpreted to mean that the underlying infrastructure platform (including physical and virtual hosts, virtual machines, instances, containers, etc.), as well as the operating system, is abstracted away from the developer. For example, in serverless computing, applications can be run in stateless compute containers that can be event triggered. Developers can create functions and then rely on the serverless cloud infrastructure to allocate the proper resources to execute the function. If the load on the function changes, then the serverless cloud infrastructure will respond accordingly, e.g., to create or kill copies of the function and scale up or down to match the demand.

System 100 further comprises an enterprise 120 that uses service provider 130 to develop and deploy a computing application in a manner that enables users to access and use the computing application by way of user devices and/or terminals 102₁-102_{N}. Enterprise 120 may employ one or more application developers that create, develop, troubleshoot, and upload the computing application to the infrastructure platform using, e.g., (i) a developer terminal and/or workstation 122 at the enterprise side and (ii) an interface 134 designated as the developer frontend at the service-provider side. In a typical service arrangement, enterprise 120 is a customer of service provider 130, whereas the users represented by terminals 102₁-102_{N} are customers of the enterprise. At the same time, terminals 102₁-102_{N} are clients of the cloud environment.

Enterprise 120 may also include an automated administrative entity 126 that operates to manage and support certain aspects of the application deployment and use. For example, administrative entity 126 may maintain a database of service-level agreements (SLAs) 106 that enterprise 120 has with the users. Administrative entity 126 may operate to provide (i) a first relevant subset 124 of SLA requirements and/or specifications to the developers represented by developer terminal 122 and (ii) a second relevant subset 128 of SLA requirements and/or specifications to service provider 130, e.g., as indicated in FIG. 1. In some embodiments, the subset 128 can be a copy of the subset 124.

In an example embodiment, one or both of the subsets 124 and 128 include the parameter Dₘₐₓ that specifies the maximum delay that can be tolerated by the computing application in question, e.g., based on a QoS guarantee contained in SLA 106. For example, for some (e.g., chat-based) applications, Dₘₐₓ can be on the order of seconds. For some other (e.g., delay-bound or gaming) applications, Dₘₐₓ can be on the order of milliseconds.

In operation, a developer uploads an application, by way of developer terminal 122 and interface 134, to service provider 130, wherein the uploaded application is typically stored in a memory 138 allocated for this purpose and labeled in FIG. 1 as “datastore.” In an example embodiment, the uploaded application can be a serverless application comprising a plurality of stateless functions, the state information for which is usually saved in datastore 138 and fetched therefrom during an execution of a function. Execution of the functions is delegated to instances 144 running in an instance pool 140 of the cloud environment. Such execution can be triggered by user requests 108 and/or other relevant events, such as changes to the pertinent data saved in datastore 138.

An automated controller 150 labeled in FIG. 1 as “instance manager” is configured to create and terminate instances 144 in instance pool 140 in response to one or more control signals 152, thereby dynamically enlarging and shrinking the instance pool as deemed appropriate. For illustration purposes and without any implied limitations, three such control signals, labeled 152₁-152₃, are shown in FIG. 1. Control signals 152₁ and 152₂ are received by instance manager 150 from a characterization module 160, and control signal 152₃ is received by the instance manager from an orchestrator module 180. A person of ordinary skill in the art will understand that, in some embodiments, instance manager 150 may receive additional control signals 152 (not explicitly shown in FIG. 1).

Also operatively coupled to instance pool 140 is an automated monitor entity 154 that is configured to monitor and log certain performance characteristics of individual instances 144. For example, monitor entity 154 may be configured to track, as a function of time, the number of user requests 108 received and processed by each individual instance 144. Monitor entity 154 may further be configured to register (i) the time at which a user request 108 is received by an individual instance 144 and (ii) the time at which an appropriate reply 110 is generated and sent back to the corresponding user terminal 102 by that individual instance 144 in response to that user request.

Characterization module 160 operates to generate a control signal 178 for orchestrator module 180 based on SLA requirements 128 and control signals 136 and 156. For each application function, control signal 178 conveys to orchestrator module 180 a respective performance model that captures the relationship between the load of the function (e.g., represented by the number of requests 108 that invoke the function) and the average delay for instance pool 140 to generate the corresponding reply 110. Characterization module 160 typically uses control signals 152₁ and 152₂ during a learning phase to cause changes in instance pool 140 that enable monitor entity 154 to acquire sufficient data for constructing a performance model that accurately approximates the actual performance of the instance pool with respect to the function, e.g., as further described below in reference to FIGS. 3-5. The performance data collected by monitor entity 154 are provided to characterization module 160 by way of a control signal 156. In an example embodiment, control signals 152₁ and 152₂ are only used during a learning phase for the initial generation or subsequent refinement of the performance model and may be disabled when an adequate performance model is already in place.

Orchestrator module 180 is configured to use the performance model(s) received from characterization module 160, along with other pertinent information (e.g., SLA 128), to configure instance manager 150, by way of control signal 152₃, to allocate an appropriate number of instances 144 in instance pool 140 to each individual function of an application. In general, orchestrator module 180 can be configured to determine such appropriate number of instances 144 based on any number of constraints, such as energy consumption, cost, server consolidation, desired level of hardware utilization, performance tradeoffs, etc. Such constraints can be used together with the performance model(s) received from characterization module 160 to optimize (e.g., using appropriately constructed cost functions or other suitable optimization algorithms) the use of hardware resources in the cloud environment.

In some embodiments, the optimization procedures executed by orchestrator module 180 may also rely on an optional input signal 176 received from a forecast engine 112. Forecast engine 112 may use a suitable forecast algorithm to predict the near-term number of incoming requests 108 and communicate this prediction to orchestrator module 180 by way of signal 176. Orchestrator module 180 can then take the received prediction into account in the process of generating control signal 152₃ to configure instance manager 150 to both proactively and optimally provision appropriate numbers of instances 144 in instance pool 140 to application functions.

In an example embodiment, characterization module 160 comprises the following sub-modules: (i) an initial provisioning sub-module 162; (ii) a log-processing sub-module 164; (iii) a learning/scaling sub-module 166; and (iv) a model-building sub-module 168. These sub-modules are described in more detail below, with some of the description being given in reference to FIGS. 3-5. An example method that can be used to operate characterization module 160 is described below in reference to FIG. 5.

When a new function (A) is uploaded to datastore 138, interface 134 notifies initial provisioning sub-module 162 about this event by way of control signal 136. In response to the notification, sub-module 162 generates control signal 152₁ that causes instance manager 150 to allocate an initial number N₀ of instances 144 to function fₙ. In an example embodiment, the value of N₀ can be customizable and may depend on the level of over-provisioning the cloud environment can tolerate, SLA requirements 128, etc. For example, a function fₙ with very demanding SLA requirements can receive a larger N₀ than a function fₙ with relatively relaxed SLA requirements.

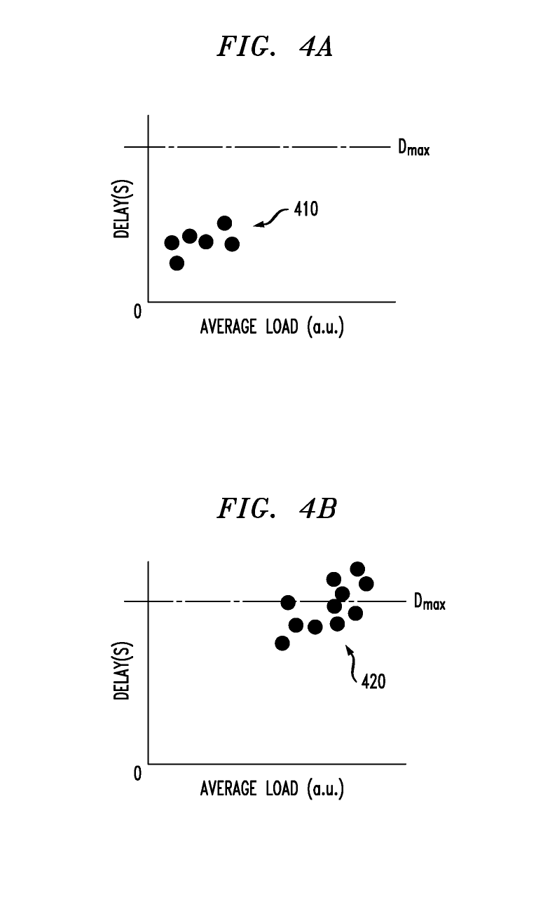

In response to control signal 152₁, instance manager 150 allocates N₀ instances 144 to function fₙ. After the allocation, monitor entity 154 starts logging information about the arrival, of requests 108, departure of replies 110, and number of processed requests for function fₙ in each allocated instance 144. Log-processing sub-module 164 can then access and/or receive the logged information by way of control signal 156. After the information is transferred to log-processing sub-module 164, the log-processing sub-module applies appropriate processing to the received information to convert it into a form that is more suitable for building the performance model corresponding to function fₙ to be used in orchestrator module 180. For example, a “delay” value for each particular request 108 can be computed by subtracting the arrival time of the request from the departure time of the corresponding reply 110. A “load” value for each particular request 108 can be computed by determining the average number of requests 108 that is being processed by the host instance 144 during this “delay” period. The resulting pair of values (load, delay) corresponding to a particular request 108 can be represented by the corresponding data point on a two-dimensional graph, e.g., as indicated in FIGS. 3-4.

As used herein, the term “data point” refers to a discrete unit of information comprising an ordered set of values. A data point is typically derived from a measurement and can be represented numerically and/or graphically. For example, a two-dimensional data point can be represented by a corresponding pair of numerical values and mapped as a point in a corresponding two-dimensional coordinate system (e.g., on a plane). A three-dimensional data point can be represented by three corresponding numerical values and mapped as a point in a corresponding three-dimensional coordinate system (e.g., in a 3D space). A three-dimensional data point can also be represented by three two-dimensional data points, each being a projection of the three-dimensional data point onto a corresponding plane. A four-dimensional data point can be represented by four corresponding numerical values and mapped as a point in a corresponding four-dimensional coordinate system, etc.

A person of ordinary skill in the art will understand that, in alternative embodiments, other relevant values that can be used in the process of constructing the performance model corresponding to function fₙ can also be computed by log-processing sub-module 164 based on the information received from monitor entity 154.

In some embodiments, log-processing sub-module 164 can be configured to generate a separate set of data points for each instance 144 that is hosting function fₙ. In some other embodiments, log-processing sub-module 164 can be configured to merge the separate sets of data points into a corresponding single set of data points.

In some embodiments, log-processing sub-module 164 can be configured to generate data points corresponding to more than two performance dimensions.

In some embodiments, log-processing sub-module 164 can be configured to generate data points whose corresponding pair of values includes at least one value that is qualitatively different from the above-described load and delay values.

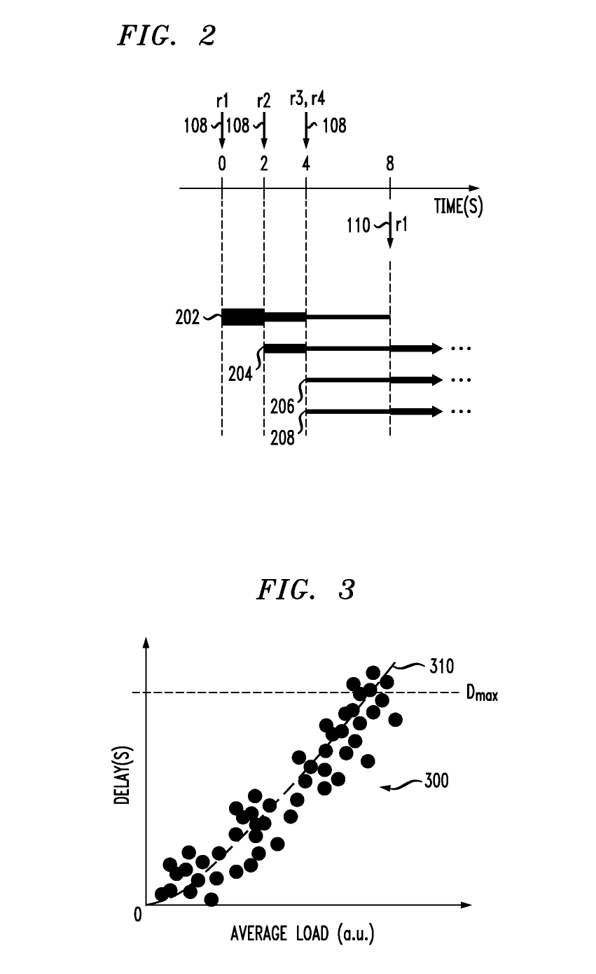

FIG. 2 graphically illustrates example data processing that can be implemented in log-processing sub-module 164 according to an embodiment. The horizontal axis in FIG. 2 shows time in seconds. The vertical arrows located above the time axis indicate the arrival times of four different requests 108, which are labeled as r1-r4. For example, the request r1 arrives at time zero. The request r2 arrives at 2 seconds. The requests r3-r4 both arrive at 4 seconds.

The vertical arrow located beneath the time axis in FIG. 2 indicates the departure time of reply 110 corresponding to the request r1. The departure times of replies 110 corresponding to the requests r2-r4 are beyond the time range shown in FIG. 2. As such, the corresponding reply arrows are not shown.

The horizontal bars 202-208 indicate the processing time periods for the requests r1-r4 by the corresponding instance 144. The variable width of each bar indicates the processing power allocated to the respective request by the instance 144 as a function of time. For example, between 0 and 2 seconds, the request r1 is the only pending request, which can use 100% of the available processing power of the instance 144 as a result.

Between 2 and 4 seconds, the requests r1 and r2 share the available processing power of the instance 144, at 50% each. Between 4 and 8 seconds, the requests r1-r4 share the available processing power of the instance 144, at 25% each, and so on.

Monitor entity 154 detects and appropriately logs the events indicated in FIG. 2 and provides the log to log-processing sub-module 164 by way of control signal 156. Based on the received log of these events, log-processing sub-module 164 can determine the delay and average-load values corresponding to the request r1, for example, as follows. The total length of the bar 202 is the “delay” corresponding to the request r1. This length is 8 seconds. The average load <L> corresponding to the request r1 can be determined using the following calculation: <L>=(1×2+2×2+4×4)/8=2.75. The first term of the sum in the nominator represents the time interval from 0 to 2 seconds (Δt₁=2 s) during which only one request was being processed by the instance 144. The second term of the sum in the nominator represents the time interval from 2 to 4 seconds (Δt₂=2 s) during which two requests were being processed by the instance 144. The third term of the sum in the nominator represents the time interval from 4 to 8 seconds (Δt₃=4 s) during which four requests were being processed by the instance 144. The denominator is the total duration of the three time intervals. The data point corresponding to the request r1 generated by log-processing sub-module 164 based on the received log of events is therefore (2.75, 8). A person of ordinary skill in the art will understand that the data points corresponding to the requests r2-r4 can be generated by log-processing sub-module 164 in a similar manner.

FIG. 3 graphically shows an example sufficient set 300 of data points that model-building sub-module 168 can use to generate a relatively accurate performance model corresponding to function fₙ. The set 300 shown in FIG. 3 is sufficient because the data points are spread relatively uniformly over the entire operational delay range of [0, Dₘₐₓ], and each of the relevant sub-ranges is sampled relatively well.

In an example embodiment, learning/scaling sub-module 166 is configured to make a conclusion about sufficiency or insufficiency of a set of data points, such as the set 300, using a suitable statistical algorithm. Multiple such algorithms are known in the pertinent art. For example, one possible statistical algorithm that can be implemented in learning/scaling sub-module 166 for this purpose can be configured to make the conclusion by analyzing certain statistical properties of the data set, such as the mean, standard deviation, skewness of the data, etc. Another possible statistical algorithm that can be implemented in learning/scaling sub-module 166 for this purpose can divide the range [0, Dₘₐₓ] into a predetermined number of relatively small sub-ranges and determine whether or not each of the sub-ranges has at least a fixed predetermined number of data points. Other suitable statistical algorithms may similarly be used as well.

FIGS. 4A-4B graphically show example insufficient sets of data points that need to be augmented by additional data points to make each of them sufficient for use by model-building sub-module 168. A set 410 of data points shown in FIG. 4A is insufficient because the data points skew towards zero, and the upper sub-ranges of the range [0, Dₘₐₓ] have no data points. A set 420 of data points shown in FIG. 4B is insufficient because the data points skew towards the delay limit, and the lower sub-ranges of the range [0, Dₘₐₓ] have no data points.

In operation, learning/scaling sub-module 166 algorithmically makes the conclusion about the insufficiency of a set of data points, e.g., as already explained above. Learning/scaling sub-module 166 then takes an appropriate remedial action to enable characterization module 160 to acquire additional data points that make the resulting set of data points sufficient for use by model-building sub-module 168. Such remedial actions can be, for example, as follows.

A first possible remedial action is to allow more time for characterization module 160 to acquire additional data points without making any changes to the configuration of instance pool 140. It is possible that, during this extra time, the load corresponding to function fₙ varies enough to allow characterization module 160 to sufficiently sample the previously undersampled sub-ranges of the range [0, Dₘₐₓ]. This particular remedial action might be effective in either of the cases shown in FIGS. 4A-4B.

A second possible remedial action is to reduce the number of instances 144 allocated to function fₙ in instance pool 140. This particular remedial action might be effective in the case shown in FIG. 4A. To implement this remedial action, learning/scaling sub-module 166 can be configured to generate an appropriate control signal 152₂ to cause instance manager 150 to terminate one or more of the corresponding instances 144. As a result, the incoming requests 108 will be processed by the fewer remaining instances 144. Provided that the request volume remains relatively steady, the average load of the remaining instances 144 will increase, thereby enabling characterization module 160 to collect data points in the upper sub-ranges of the range [0, Dₘₐₓ].

A third possible remedial action is to increase the number of instances 144 allocated to function fₙ in instance pool 140. This particular remedial action might be effective in the case shown in FIG. 4B. To implement this remedial action, learning/scaling sub-module 166 can be configured to generate an appropriate control signal 152₂ to cause instance manager 150 to allocate one or more additional instances 144 for function fₙ in instance pool 140. As a result, the incoming requests 108 will be processed by a larger number of instances 144. Provided that the request volume remains relatively steady, the average load of the larger number of instances 144 will be lower, which will enable characterization module 160 to collect data points in the lower sub-ranges of the range [0, Dₘₐₓ].

A person of ordinary skill in the art will understand that one or more remedial actions may have to be taken by learning/scaling sub-module 166 to iteratively convert an insufficient set, such as one of the sets shown in FIGS. 4A-4B, into a sufficient set, which can be analogous to the set shown in FIG. 3.

Referring back to FIG. 3, once a sufficient set of data points, such as the set 300, is acquired by characterization module 160, model-building sub-module 168 can proceed to generate a numerical or analytical model that fits the set. A dashed curve 310 shows an example of such a model. In different embodiments, different regression functions can be used for the model construction. Examples of such functions include but are not limited to a linear function, a polynomial, an exponential function, a logarithmic function, and various combinations thereof. In some embodiments, different regression functions can be used to fit data in different sub-ranges of [0, Dₘₐₓ].

After model-building sub-module 168 has generated an acceptable performance model corresponding to function fₙ, e.g., using one or more regression functions or other suitable computational techniques, one or more parameters of the performance model can be transferred, by way of control signal 178, to orchestrator module 180. In response to receiving these parameters, orchestrator module 180 can begin to use the performance model to proactively and optimally provision and allocate function fₙ with an optimal number of instances 144, thereby beneficially satisfying the user demand while optimizing (e.g., maximizing) the hardware utilization in the cloud environment.

FIG. 5 shows a flowchart of an operating method 500 that can be implemented in characterization module 160 according to an embodiment. Method 500 is typically executed during a learning phase.

Step 502 of method 500 serves as a trigger for the execution of the subsequent steps when a performance model needs to be updated or generated de novo. For example, step 502 can cause the processing of method 500 to be directed to step 504 when: (i) a new function fₙ is uploaded through interface 134; (ii) a relevant configuration or operating parameter has been changed for instance pool 140 or for the overall system; and (iii) a timer that counts down the lifetime of the currently used performance model reached zero. A person of ordinary skill in the art will understand that step 502 can be configured to cause the processing of method 500 to be directed to step 504 for other applicable reasons as well.

At step 504, initial-provisioning sub-module 162 of characterization module 160 generates control signal 152₁ in a manner that causes instance manager 150 to allocate an initial number N₀ of instances 144 to function fₙ. In some embodiments, the value of N₀ may depend on the type of trigger that was received at the preceding step 502. In some other embodiments, the value of N₀ can be a fixed number.

In response to control signal 152₁ generated at step 504, instance manager 150 allocates N₀ instances 144 to function fₙ. After the allocation, monitor entity 154 begins to monitor and log the pertinent events and performance characteristics of individual instances 144, e.g., as already described above. The logged events/characteristics are transferred to characterization module 160 by way of control signal 156.

At step 506, log-processing sub-module 164 of characterization module 160 receives the logged data from monitor entity 154. Log-processing sub-module 164 then appropriately processes the received logged data to generate a corresponding set of data points. As already indicated above, the resulting set of data points can be similar, e.g., to the set 300 shown in FIG. 3 or to one of the sets 410 and 420 shown in FIGS. 4A-4B, respectively. Other qualitative types of the sets are also possible.

At step 508, learning/scaling module 166 algorithmically evaluates the set of data points generated at step 506 for sufficiency or insufficiency, e.g., as already explained above. If the set is deemed insufficient, then the processing of method 500 is directed to step 510. Otherwise, the processing of method 500 is directed to step 512.

At step 510, learning/scaling module 166 generates control signal 1522 in a manner that causes instance manager 150 to change the number of instances 144 allocated to function fₙ. Depending on the type of insufficiency, the number of instances 144 can be increased or decreased, e.g., as explained above in reference to FIGS. 4A-4B.

In response to control signal 152₂ generated at step 504, instance manager 150 appropriately changes the number of instances 144 allocated to function fₙ. Monitor entity 154 continues to monitor and log the pertinent performance characteristics of individual instances 144 after the change. The logged characteristics continue to be transferred to characterization module 160 by way of control signal 156. The processing of method 500 is directed back to step 506.

A person of ordinary skill in the art will understand that the processing loop having steps 506-510 might need to be repeated several times before the processing of method 500 can proceed to step 512.

At step 512, model-building sub-module 168 generates a performance model corresponding to function fₙ, e.g., as already explained above, and sends the parameters of the generated performance model to orchestrator module 180. The processing of method 500 is then directed back to step 502.

FIG. 6 shows a block diagram of a networked computer 600 that can be used by service provider 130 in cloud-computing system 100 according to an embodiment. Multiple instances of computer 600 or functional equivalents thereof can be used in the infrastructure platform of service provider 130. In some embodiments, such multiple instances can be arranged to implement a datacenter.

Computer 600 comprises a central processing unit (CPU) 610, a memory 620, a storage device 630, and one or more input/output (I/O) components 650, three of which (labeled 650₁-650₃) are shown in FIG. 6 for illustration purposes. All of these elements of computer 600 are interconnected using an internal bus 640. Computer 600 is connected to other elements of the infrastructure platform of service provider 130 by way of one or more external links 660.

CPU 610 is configurable to (i) host one or more instances 144 and/or (ii) run the processing corresponding to one or more service and/or control modules of the cloud environment, such as characterization module 160, orchestrator module 180, etc. Memory 620 can be used, e.g., for temporary storage of transitory information in a manner that enables fast access to that information by CPU 610. Storage device 630 can be used, e.g., for more-permanent storage of information in a non-volatile manner. For example, one or more storage devices 630 can be used to implement datastore 138. I/O components 650 can be connected to system interfaces, such as interface 134, etc.

According to an example embodiment disclosed above in reference to FIGS. 1-6, provided is an apparatus (e.g., 100, FIG. 1) comprising: an instance pool (e.g., 140, FIG. 1) configurable to process requests (e.g., 108, FIG. 1) that invoke a function (e.g., fₙ) of a computing application that is executable using a cloud environment, the instance pool being a part of the cloud environment; an automated control entity (e.g., 150/154/180, FIG. 1) operatively connected to the instance pool; and a characterization module (e.g., 160, FIG. 1) operatively connected to the automated control entity and configured to: generate (e.g., at 506, FIG. 5) a first set of data points (e.g., 300, 410, 420, FIGS. 3-4) by processing a log of events corresponding to a first instance (e.g., 144, FIG. 1) allocated in the instance pool to processing the requests, the log of events being received (e.g., by way of 156, FIG. 1) by the characterization module from the automated control entity; and generate (e.g., at 510, FIG. 5) a first control signal (e.g., 152₂, FIG. 1) configured to cause the control entity to change a number of instances allocated to the processing of the requests in the instance pool in response to a determination of insufficiency having been made by the characterization module (e.g., at 508) with respect to the first set of data points.

In some embodiments of the above apparatus, the instance pool is implemented using a plurality of networked computers (e.g., 600, FIG. 6).

In some embodiments of any of the above apparatus, the characterization module is implemented using a networked computer (e.g., 600, FIG. 6) operatively connected to the automated control entity.

In some embodiments of any of the above apparatus, the apparatus further comprises a memory (e.g., 138, FIG. 1) operatively connected to the instance pool and configured to store the function of the computing application, the computing application being a serverless application comprising a plurality of stateless functions, the function being one of the stateless functions.

In some embodiments of any of the above apparatus, the characterization module is further configured to generate (e.g., at 512, FIG. 5) a performance model in response to a determination of sufficiency having been made by the characterization module (e.g., at 508) with respect to the first set of data points, the performance model providing an approximate quantitative description of a response of the first instance to the requests.

In some embodiments of any of the above apparatus, the characterization module comprises: a log-processing sub-module (e.g., 164, FIG. 1) configured to receive the log of events from the automated control entity and generate the first set of data points; and a scaling sub-module (e.g., 166, FIG. 1) operatively connected to the log-processing sub-module and configured to generate the first control signal in response to the determination of insufficiency and apply the first control signal to the characterization module.

According to another example embodiment disclosed above in reference to FIGS. 1-6, provided is a computer-aided method (e.g., 500, FIG. 5) of configuring a cloud environment, the computer-aided method comprising: generating (e.g., 506, FIG. 5) a first set of data points (e.g., 300, 410, 420, FIGS. 3-4) by processing a log (e.g., received by way of 156, FIG. 1) of events corresponding to a first instance (e.g., 144, FIG. 1) allocated in an instance pool (e.g., 140, FIG. 1) to processing requests (e.g., 108, FIG. 1) that invoke a function (e.g., fₙ) executed using the cloud environment; and generating (e.g., 510, FIG. 5) a first control signal (e.g., 152₂, FIG. 1) to change a number of instances allocated to the processing of said requests in the instance pool in response to a determination of insufficiency having been made (e.g., at 508, FIG. 5) with respect to the first set of data points.

In some embodiments of the above method, the method further comprises generating (e.g., using looped processing through 506, FIG. 5) additional data points for the first set of data points after the number of instances allocated to the processing of said requests in the instance pool has been changed in response to the first control signal.

In some embodiments of any of the above methods, the data points are generated such that each data point comprises a respective first value and a respective second value, wherein the first value represents a time delay between a request having been received by an allocated instance and a corresponding reply (e.g., 110, FIG. 1) having been generated by the allocated instance in response to said request; and wherein the second value represents an average number of requests being processed by the allocated instance during the time delay.

In some embodiments of any of the above methods, the method further comprises determining a distribution of the data points of the first set over a plurality of sub-ranges of an operational time-delay range (e.g., [0, Dₘₐₓ], FIGS. 3-4).

In some embodiments of any of the above methods, the method further comprises making the determination of insufficiency if at least one of the plurality of the sub-ranges has fewer data points than a predetermined fixed number.

In some embodiments of any of the above methods, the method is configured to use a delay value (e.g., Dₘₐₓ, FIGS. 3-4) from a service-level agreement (e.g., 106, FIG. 1) corresponding to one or more originators (e.g., 102, FIG. 1) of the requests as an upper bound of the operational time-delay range.

In some embodiments of any of the above methods, the method further comprises increasing the number of instances allocated to the processing of said requests in the instance pool if at least one of lower sub-ranges (e.g., located within [0, 0.5 Dₘₐₓ]) of the operational time-delay range has fewer data points of the first set than a predetermined fixed number.

In some embodiments of any of the above methods, the method further comprises decreasing the number of instances allocated to the processing of said requests in the instance pool if at least one of upper sub-ranges (e.g., located within [0.5 Dₘₐₓ, Dₘₐₓ]) of the operational time-delay range has fewer data points of the first set than a predetermined fixed number.

In some embodiments of any of the above methods, the method further comprises generating (e.g., 512, FIG. 5) a performance model in response to a determination of sufficiency having been made (e.g., at 508) with respect to the first set of data points, the performance model providing an approximate quantitative description of a response of the first instance to the requests.

In some embodiments of any of the above methods, the method further comprises generating (e.g., as part of 512, FIG. 5) a second control signal (e.g., 178, FIG. 1) to convey one or more parameters of the performance model to an automated control entity (e.g., 180/150/154, FIG. 1) configured to control the instance pool.

In some embodiments of any of the above methods, the method further comprises generating (e.g., as part of 512, FIG. 5) the performance model using a regression applied to the first set of data points.

In some embodiments of any of the above methods, the method further comprises generating (e.g., 506, FIG. 5) a second set of data points (e.g., 300, 410, 420, FIGS. 3-4) by processing the log of events corresponding to a second instance (e.g., another 144, FIG. 1) allocated in the instance pool to the processing of the requests; and wherein the second set of data points represents performance of the second instance with respect to the function.

In some embodiments of any of the above methods, the method further comprises: merging the first set of data points and the second set of data points; and making the determination of insufficiency or a determination of sufficiency using a resulting merged set of data points.

In some embodiments of any of the above methods, the method further comprises performing the step of generating the first set of data points in response to the function being uploaded to a designated memory (e.g., 138, FIG. 1) of the cloud environment (as sensed at 502, FIG. 5).

In some embodiments of any of the above methods, the method further comprises performing the step of generating the first set of data points in response to a timer having counted down to zero from a predetermined fixed time (as determined at 502, FIG. 5).

While this disclosure includes references to illustrative embodiments, this specification is not intended to be construed in a limiting sense. Various modifications of the described embodiments, as well as other embodiments within the scope of the disclosure, which are apparent to persons skilled in the art to which the disclosure pertains are deemed to lie within the principle and scope of the disclosure, e.g., as expressed in the following claims.

Some embodiments may be implemented as circuit-based processes, including possible implementation on a single integrated circuit.

Some embodiments can be embodied in the form of methods and apparatuses for practicing those methods. Some embodiments can also be embodied in the form of program code recorded in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing the patented invention(s). Some embodiments can also be embodied in the form of program code, for example, stored in a non-transitory machine-readable storage medium including being loaded into and/or executed by a machine, wherein, when the program code is loaded into and executed by a machine, such as a computer or a processor, the machine becomes an apparatus for practicing the patented invention(s). When implemented on a general-purpose processor, the program code segments combine with the processor to provide a unique device that operates analogously to specific logic circuits.

Unless explicitly stated otherwise, each numerical value and range should be interpreted as being approximate as if the word “about” or “approximately” preceded the value or range.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

A person of ordinary skill in the art would readily recognize that steps of various above-described methods can be performed by programmed computers. Herein, some embodiments are intended to cover program storage devices, e.g., digital data storage media, which are machine or computer readable and encode machine-executable or computer-executable programs of instructions where said instructions perform some or all of the steps of methods described herein. The program storage devices may be, e.g., digital memories, magnetic storage media such as a magnetic disks or tapes, hard drives, or optically readable digital data storage media. The embodiments are also intended to cover computers programmed to perform said steps of methods described herein.

The description and drawings merely illustrate the principles of the disclosure. It will thus be appreciated that those of ordinary skill in the art will be able to devise various arrangements that, although not explicitly described or shown herein, embody the principles of the disclosure and are included within its spirit and scope. Furthermore, all examples recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions. Moreover, all statements herein reciting principles, aspects, and embodiments of the disclosure, as well as specific examples thereof, are intended to encompass equivalents thereof.

The functions of the various elements shown in the figures, including any functional blocks labeled as “processors” and/or “controllers,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

What is claimed is:

1. A non-transitory machine-readable medium, having encoded thereon program code, wherein, when the program code is executed by a machine, the machine implements a computer-aided method of configuring a cloud environment, the computer-aided method comprising:
generating a first set of data points by processing a log of events corresponding to a first instance allocated in an instance pool to processing requests that invoke a function executed using the cloud environment; and
generating a first control signal to change a number of instances allocated to the processing of said requests in the instance pool in response to a determination of insufficiency having been made with respect to the first set of data points.

2. The non-transitory machine-readable medium of claim 1, wherein the program code is configured to cause the computer-aided method to further comprise:
generating additional data points for the first set of data points after the number of instances allocated to the processing of said requests in the instance pool has been changed in response to the first control signal.

3. The non-transitory machine-readable medium of claim 1, wherein the program code is configured to cause the computer-aided method to generate the data points such that each data point comprises a respective first value and a respective second value,
wherein the first value represents a time delay between a request having been received by an allocated instance and a corresponding reply having been generated by the allocated instance in response to said request; and
wherein the second value represents an average number of requests being processed by the allocated instance during the time delay.

4. The non-transitory machine-readable medium of claim 3, wherein the program code is configured to cause the computer-aided method to further comprise:
determining a distribution of the data points of the first set over a plurality of sub-ranges of an operational time-delay range.

5. The non-transitory machine-readable medium of claim 4, wherein the program code is configured to cause the computer-aided method to further comprise:
making the determination of insufficiency if at least one of the plurality of the sub-ranges has fewer data points than a predetermined fixed number.

6. The non-transitory machine-readable medium of claim 4, wherein the program code is configured to cause the computer-aided method to use a delay value from a service-level agreement corresponding to one or more originators of the requests as an upper bound of the operational time-delay range.

7. The non-transitory machine-readable medium of claim 4, wherein the program code is configured to cause the computer-aided method to further comprise:
increasing the number of instances allocated to the processing of said requests in the instance pool if at least one of lower sub-ranges of the operational time-delay range has fewer data points of the first set than a predetermined fixed number.

8. The non-transitory machine-readable medium of claim 4, wherein the program code is configured to cause the computer-aided method to further comprise:
decreasing the number of instances allocated to the processing of said requests in the instance pool if at least one of upper sub-ranges of the operational time-delay range has fewer data points of the first set than a predetermined fixed number.

9. The non-transitory machine-readable medium of claim 1, wherein the program code is configured to cause the computer-aided method to further comprise:
generating a performance model in response to a determination of sufficiency having been made with respect to the first set of data points, the performance model providing an approximate quantitative description of a response of the first instance to the requests.

10. The non-transitory machine-readable medium of claim 9, wherein the program code is configured to cause the computer-aided method to further comprise:
generating a second control signal to convey one or more parameters of the performance model to an automated control entity configured to control the instance pool.

11. The non-transitory machine-readable medium of claim 9, wherein the program code is configured to cause the computer-aided method to further comprise:
generating the performance model using a regression applied to the first set of data points.

12. The non-transitory machine-readable medium of claim 1, wherein the program code is configured to cause the computer-aided method to further comprise:
generating a second set of data points by processing the log of events corresponding to a second instance allocated in the instance pool to the processing of the requests; and
wherein the second set of data points represents performance of the second instance with respect to the function.

13. The non-transitory machine-readable medium of claim 12, wherein the program code is configured to cause the computer-aided method to further comprise:
merging the first set of data points and the second set of data points; and
making the determination of insufficiency or a determination of sufficiency using a resulting merged set of data points.

14. The non-transitory machine-readable medium of claim 1, wherein the program code is configured to cause the computer-aided method to further comprise:
performing the step of generating the first set of data points in response to the function being uploaded to a designated memory of the cloud environment.

15. The non-transitory machine-readable medium of claim 1, wherein the program code is configured to cause the computer-aided method to further comprise:
performing the step of generating the first set of data points in response to a timer having counted down to zero from a predetermined fixed time.

16. An apparatus comprising:
an automated control entity operatively connected to an instance pool configurable to process requests that invoke a function of a computing application that is executable using a cloud environment, the instance pool being a part of the cloud environment; and
a characterization module operatively connected to the automated control entity and configured to:
generate a first set of data points by processing a log of events corresponding to a first instance allocated in the instance pool to processing the requests, the log of events being received by the characterization module from the automated control entity; and
generate a first control signal configured to cause the control entity to change a number of instances allocated to the processing of the requests in the instance pool in response to a determination of insufficiency having been made by the characterization module with respect to the first set of data points.

17. The apparatus of claim 16, wherein the characterization module comprises:
a log-processing sub-module configured to receive the log of events from the automated control entity and generate the first set of data points; and
a scaling sub-module operatively connected to the log-processing sub-module and configured to generate the first control signal in response to the determination of insufficiency and apply the first control signal to the characterization module.

18. The apparatus of claim 16, wherein the characterization module is implemented using a networked computer operatively connected to the automated control entity.

19. The apparatus of claim 16, further comprising a memory operatively connected to the instance pool and configured to store the function of the computing application, the computing application being a serverless application comprising a plurality of stateless functions, the function being one of the stateless functions.

20. The apparatus of claim 16, wherein the characterization module is further configured to generate a performance model in response to a determination of sufficiency having been made by the characterization module with respect to the first set of data points, the performance model providing an approximate quantitative description of a response of the first instance to the requests.
